(19) United States
(12) Patent Application Publication
(10) Pub. No.: US 2026/0133958 A1
(43) Pub. Date: May 14, 2026

(54) TRANSACTIONAL SYSTEM FOR DATA LAKE TABLES BY EXTENDING A RELATIONAL DATABASE SYSTEM

(71) Applicant: Snowflake Inc., Bozeman, MT (US)

(72) Inventors: Utku Azman, Istanbul (TR); Önder Kalaci, Istanbul (TR); Martin Slot, Haarlem (NL)

(21) Appl. No.: 19/383,988

(22) Filed: Nov. 10, 2025

Related U.S. Application Data
(60) Provisional application No. 63/719,465, filed on Nov. 12, 2024.

(51) Int. Cl. G06F 16/23; G06F 16/22; G06F 16/2452; G06F 16/25

(52) U.S. Cl. CPC G06F 16/2365; G06F 16/2282; G06F 16/2308; G06F 16/24526; G06F 16/25

(57) ABSTRACT

The subject technology provides embodiments for integrating data lake functionality within a relational database management system (RDBMS) through a specialized RDBMS Data Lake Module. The subject technology enables database systems to natively support data lake table formats using SQL syntax. The system implements dual-mode access patterns supporting both internal operations through standard RDBMS interfaces and external operations via a catalog API, enabling multiple systems to access the same data lake tables without duplication. The RDBMS Data Lake Module comprises three integrated components: a lake format engine for translating SQL queries to object storage operations, a catalog manager for maintaining transactional consistency, and a catalog API for external system coordination.

### CROSS-REFERENCE TO RELATED APPLICATIONS

This application claims priority to U.S. Provisional Ser. No. 63/719,465 , filed on Nov. 12, 2024, entitled “TRANSACTIONAL SYSTEM FOR DATA LAKE TABLES BY EXTENDING A RELATIONAL DATABASE SYSTEM,” and the contents of which are incorporated herein by reference in its entirety for all purposes.

### TECHNICAL FIELD

Embodiments of the disclosure relate generally to database management systems and data lake technologies, specifically to systems and methods for integrating data lake functionality within traditional relational database management systems (RDBMS).

### BACKGROUND

Data lake tables are relational database tables that are stored as a collection of data and metadata files in object storage. The data lake table metadata files describe the state of the table and history of transactions on the table. The current state of the data lake table may be kept in a database to ensure transactional consistency. External software systems can query data lake tables directly by obtaining the current state of a data lake table and its location in object storage from the database via a network application programming interface (API), and then retrieving the data lake table data files and metadata files directly from object storage. The combination of database and API is referred to as the “catalog”, and the network API as the “catalog API”.

### BRIEF DESCRIPTION OF THE DRAWINGS

The present disclosure will be understood more fully from the detailed description given below and from the accompanying drawings of various embodiments of the disclosure.

FIG. 1 illustrates an example of a Relational Database Management System (RDBMS) that performs query processing, in conjunction with a RDBMS data lake module, in response to a query of a database stored in a storage in accordance with one embodiment.

FIG. 2 illustrates an example of a dual-mode read operation architecture, in accordance with an embodiment of the subject technology.

FIG. 3 illustrates a dual-mode write operation architecture, in accordance with an embodiment of the subject technology.

FIG. 4 illustrates a method in accordance with one embodiment.

FIG. 5 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Embodiments of the subject technology enable relational database systems such as PostgreSQL, Oracle, and SQL Server to natively support data lake table formats (such as Apache Iceberg tables) through an RDBMS Data Lake Module. More specifically, an approach to data lake management is provided by implementing a data lake catalog directly within a relational database management system (RDBMS). Unlike other data lake architectures that rely on separate catalog systems such as REST catalogs or file system-based catalogs, the subject system integrates catalog functionality into the RDBMS itself through the RDBMS Data Lake Module. This integration enables users to create and manage data lake tables (such as Iceberg tables) directly from within a relational database using SQL syntax. As mentioned herein, “SQL syntax” is understood to include standard SQL syntax and SQL-extended syntax. For example, standard SQL syntax refers to the official, vendor-neutral language defined by the ANSI/ISO standards. In comparison, SQL extended syntax refers to the proprietary, extra commands and features added by specific database vendors including PostgreSQL, Oracle, Microsoft SQL Server, and the like.

An aspect of the subject system is its ability to provide unified transactional semantics across both traditional database tables and data lake tables. The subject system introduces “data lake table representations” stored within the database storage that serve as pointers to the actual data files residing in object storage. This architectural innovation allows users to interact with data lake tables as if they were native database tables, while the underlying data remains stored in object storage formats such as Parquet. The RDBMS Data Lake Module ensures that transactions involving both native tables and data lake tables maintain ACID properties and can be committed or rolled back atomically.

The subject technology implements a dual-mode access pattern supporting both “internal” and “external” operations. Internal operations allow users to interact with data lake tables using standard RDBMS syntax, with the system transparently handling the complexity of accessing data stored in object storage. External operations provide a catalog API that enables external systems (e.g., Snowflake, other analytics platforms, and the like) to access the same data lake tables independently, promoting interoperability while maintaining data consistency. This dual-mode approach addresses the critical industry need for data lake tables to be accessible by multiple systems without data duplication.

In addition, the subject system includes a capability to extend traditional RDBMS functionality to support direct creation of data lake tables using familiar SQL syntax. Users can execute commands such as “CREATE TABLE . . . USING ICEBERG” within their existing PostgreSQL, Oracle, or SQL Server environments to automatically generate Iceberg tables with data and metadata files stored in object storage. This represents a shift from a current practice where data lake table creation requires specialized tools and separate systems, instead enabling enterprises to leverage their existing RDBMS infrastructure and expertise while gaining access to modern data lake capabilities.

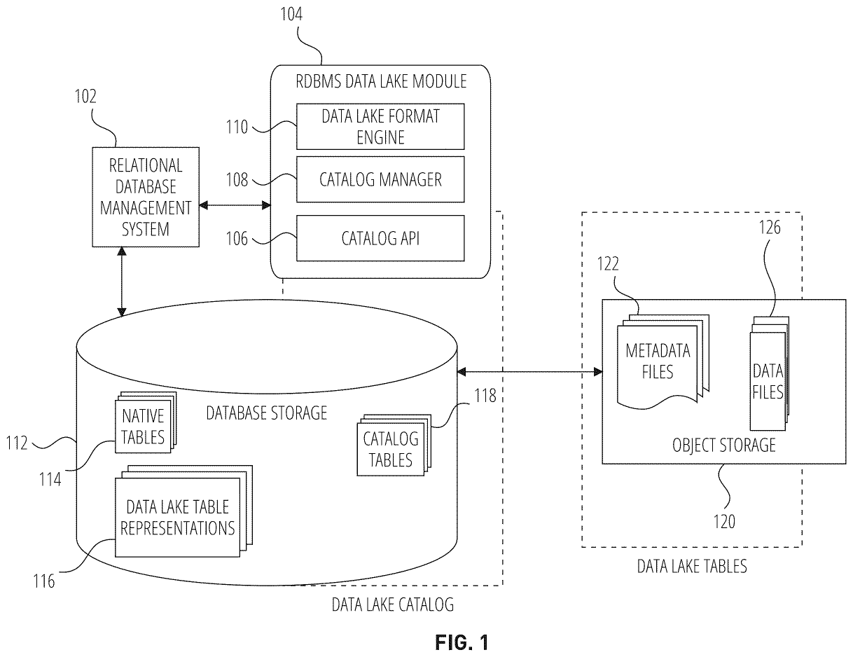

FIG. 1 illustrates an example of a Relational Database Management System (RDBMS) that performs query processing, in conjunction with a RDBMS data lake module, in response to a query of a database stored in a storage in accordance with one embodiment.

FIG. 1 illustrates the overall system architecture, depicting the integration of a relational database management system with data lake functionality through an RDBMS data lake module 104. The subject system includes several components that work in coordination to enable unified transactional operations across both traditional database tables and data lake tables stored in object storage.

A relational database management system 102 represents an RDBMS such as PostgreSQL, Oracle, SQL Server, and the like, that provides standard database functionality and query processing capabilities. This relational database management system 102 serves as the database platform that users interact with using SQL syntax and operations. The relational database management system 102 is operatively coupled to the RDBMS data lake module 104, which extends database functionality to support data lake table operations.

The RDBMS data lake module 104 includes several interconnected components that enable the RDBMS to manage data lake native tables 114. A data lake format engine 110 implements logic to query and manipulate data lake data file formats, translating standard RDBMS syntax into operations that can be executed against data files stored in object storage. The catalog manager 108 maintains and updates the metadata information about data lake tables, maintaining consistency between the database representations and the actual files in object storage. The catalog API 106 provides a programmatic interface that enables external systems to interact with the data lake catalog, facilitating interoperability while maintaining data consistency across multiple accessing systems.

A database storage 112 provides persistent storage for the RDBMS and stores various types of tables that collectively form a Data Lake Catalog. Native tables 114 represent database tables that store data directly within the database storage using RDBMS storage mechanisms. Data lake table representations 116 serve as pointer or reference structures within the database that correspond to data lake tables whose actual data resides in object storage, enabling users to interact with remote data as if it were locally stored. Catalog tables 118 maintain the current state and metadata information for all data lake tables, ensuring transactional consistency and providing the foundation for both internal and external access to data lake tables.

Object storage 120 represents storage that stores data lake tables in an open format accessible by multiple systems. The object storage 120 includes metadata files 122 that describe the structure, schema, and transaction history of each data lake table, along with data files 126 that include the table data that may be stored in optimized formats such as Parquet for efficient analytics operations. The combination of metadata files and data files in object storage represents a physical manifestation of data lake tables, which can be accessed independently by external systems while remaining coordinated through the RDBMS data lake module 104 to help ensure consistency and transactional integrity.

As shown in FIG. 1, relational database management system 102 is coupled to RDBMS data lake module 104 and database storage 112, which in tum is coupled to object storage 120. Each of relational database management system 102, RDBMS data lake module 104, database storage 112 and object storage 120 can include a processor and a memory that is coupled to the processor and that can include instructions to be executed by the respective processor. For example, each processor can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a graphics processing unit (GPU), a programmable logic controller (PLC), a remote cluster of one or more processors associated with a cloud-based computing infrastructure and/or the like. The each memory can be, for example, a random-access memory (RAM), a memory buffer, a hard drive, a read-only memory (ROM), an erasable programmable read-only memory (EPROM), and/or the like. Each memory can store, for example, one or more software modules and/or code that can include instructions to cause the connected processor to perform one or more processes, functions, and/or the like. In some embodiments, relational database management system 102 and/or the RDBMS data lake module 104 can include any suitable hardware-based computing devices such as, for example, a server and/or like. Similarly, the database storage 112 and/or the object storage 120 can implement a database (or database server), which can include a collection of data configured for retrieval and storage. More specifically, the database server(s) can execute database management software such as, for example, MySQL, PostgreSQL, MongoDB®, and/or the like.

Each of relational database management system 102, RDBMS data lake module 104, database storage 112 and object storage 120 can be directly connected to other devices as shown in FIG. 1, or coupled through a network (not shown) to the other devices using wired connections and/or wireless connections. Such a network can include various configurations and protocols, including, for example, short range communication protocols, Bluetooth®, Bluetooth® LE, the Internet, World Wide Web, intranets, virtual private networks, wide area networks, local networks, private networks using communication protocols proprietary to one or more companies, Ethernet, WiFi® and/or Hypertext Transfer Protocol (HTTP), cellular data networks, satellite networks, free space optical networks and/or various combinations of the foregoing.

RDBMS data lake module 104 can include (store) a data lake format engine 110, catalog manager 108 and a catalog application programming interface (API) 106. The data lake format engine 110 includes (implements) logic (e.g., processor instructions or code) to query a particular data lake data file format. In internal reads and writes (discussed below), this logic translates the queries written in the syntax of the RDBMS to operations that can be executed on the data files 126 of object storage 120 (also referred to as “data lake data files”). In external reads and writes (discussed below), an external system 132 implements its own query logic to query data files 126 of object storage 120.

Database storage 112 stores native tables database storage 112, data lake table representations 116 and catalog tables 118. Object storage 120 stores metadata files 122 and data files 126, which can be collectively referred to “data lake tables”. Each data lake table stored at object storage 120 is associated with metadata files 122 and data files 126. Thus, each of the data lake table representations 116 of database storage 112 can point to a set of metadata files 122 and data files 126 associated with the data lake table representations 116.

One or more embodiments described herein (also referred to as a “system”) can support transactions across both multiple data lake tables and native tables 114 (also referred to as “regular RDBMS tables”. To provide this capability, the subject system as shown in FIG. 1 implements storage and querying methods for data lake table formats in relational database management system 102. In doing so, RDBMS data lake module 104 enables the relational database management system 102 to store the current state of the data lake table in internal RDBMS catalog tables 118 stored in the database storage 112, and to offer catalog API 106 used for querying the data lake table stored in object storage 120. Once the relational database management system 102 is implemented with the RDBMS data lake module 104, the relational database management system 102 with the added RDBMS data lake module 104 can collectively act as a query engine and catalog for data lake tables.

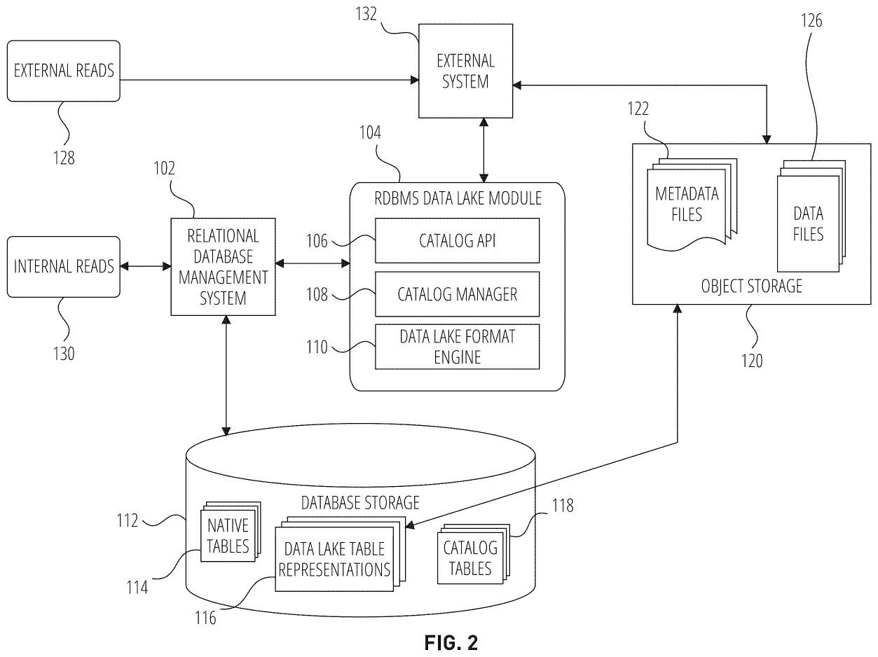

FIG. 2 illustrates an example of a dual-mode read operation architecture, in accordance with an embodiment of the subject technology. In the example of FIG. 2, the architecture enables both external and internal read transactions against data lake tables stored in object storage 120. FIG. 2 depicts the comprehensive flow of data access operations that leverage the RDBMS data lake module 104 to provide unified transactional semantics across traditional database tables and modern data lake formats.

The external read pathway beginning from external reads 128 shows how an external system 132 can access data lake tables independently of the RDBMS while still maintaining coordination through the subject system's catalog infrastructure. In this operational mode, the external system 132 utilizes external libraries specifically designed for the data lake format to directly read data from object storage 120, which stores both metadata files 122 and data files 126 that collectively form the data lake tables. The external system 132 coordinates this access by first obtaining the current state information from the RDBMS data lake module 104 through the catalog API 106, ensuring that the external system accesses the most recent committed version of the data lake tables. This catalog API interaction is vital for maintaining data consistency, as it provides the external system 132 with the necessary metadata information to locate and properly interpret the data files stored in object storage 120.

The internal read pathway starting from internal reads 130 illustrates how users can access data lake tables through the RDBMS interface of relational database management system 102 using SQL syntax. In this mode, users interact directly with the relational database management system 102 using familiar database query syntax, while the RDBMS data lake module 104 transparently handles the complexity of accessing data stored in object storage format. The data lake format engine 110 within the RDBMS data lake module 104 performs the function of translating standard RDBMS queries into operations that can be executed against the data files 126 in object storage 120. The catalog manager 108 maintains the current state information and metadata required for these operations, while the catalog tables 118 stored in the database storage 112 provide the transactional consistency guarantees that help ensure internal reads access the latest committed version of all data lake tables.

The architecture shown in FIG. 2 show the coordination between the database storage 112 and object storage 120 components that enables the subject system's dual-access pattern. The data lake table representations 116 stored within the database storage 112 serve as intelligent pointers that connect the database interface to the actual data lake content residing in object storage 120, allowing the RDBMS Data Lake Module 104 to seamlessly bridge the gap between relational database operations and object storage-based data lake architectures. This coordination helps ensures that both external and internal read operations can be performed concurrently while maintaining full transactional consistency and ACID properties across the entire system.

In an example, read transactions on a data lake table stored in object storage 120 can be performed in two ways:
1. By obtaining the current state of the data lake table via the catalog API 106 implemented through (e.g., stored and maintained at) the RDBMS data lake module 104 and then reading the metadata files 122 and data files 126 stored in the object storage 120 directly (also referred to herein as “external reads”)
2. By querying a representation of the data lake table provided by the RDBMS data lake module 104, using the regular query syntax of the database system (also referred to herein as “internal reads”)

In either case, the current state of the table is obtained from internal catalog tables 118 that are modified using regular database transactions. That way, both internal reads 130 and external reads 128 access the latest committed version of all data lake tables.

For internal reads 130, the RDBMS data lake module 104 implements the capability to perform a scan of data files 126 and metadata files 122 in object storage 120 according to the data lake table format. For external reads ERs, those steps are implemented by a separate library (not shown in FIG. 2).

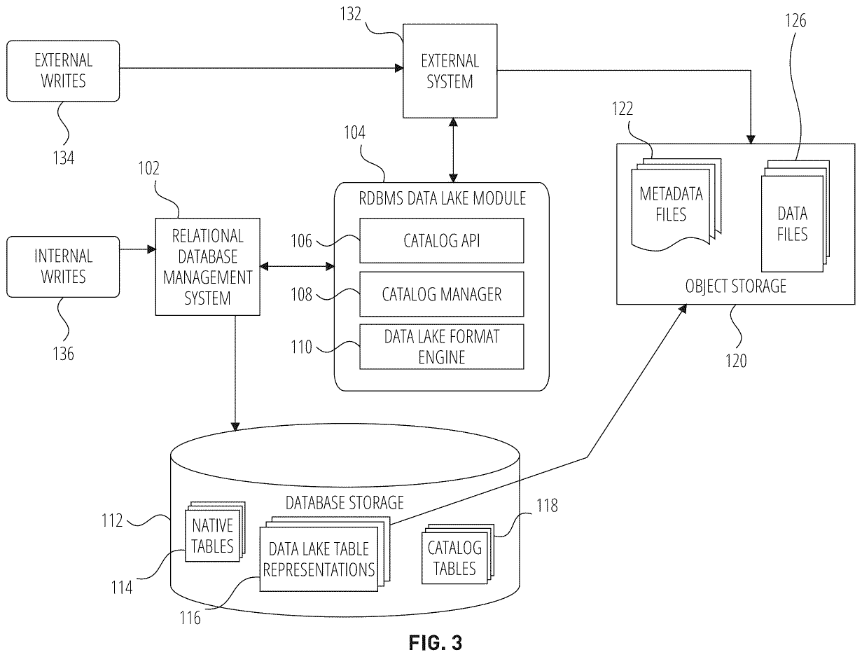

FIG. 3 illustrates a dual-mode write operation architecture, in accordance with an embodiment of the subject technology. In the example of FIG. 3, the architecture enables both external and internal write transactions against data lake tables stored in object storage while maintaining transactional consistency and data integrity. FIG. 3 depicts the comprehensive flow of write operations that leverage the RDBMS data lake module 104 to coordinate write access between database systems and external systems, ensuring that all modifications to data lake tables are properly validated and committed in a coordinated manner.

The external write pathway, starting from external writes 134, shows how an external system 132 can independently perform write operations to data lake tables while still maintaining coordination with the RDBMS infrastructure. In this operational mode, the external system 132 first writes data independently to object storage 120, creating or modifying the data files 126 and metadata files 122 that form the data lake table structure. Following the completion of the write operation to object storage 120, the external system 132 initiates an update request to modify the current state information maintained by the RDBMS data lake module 104. This coordination step facilitates maintaining consistency across the subject system, as the RDBMS data lake module 104 has the capability to validate or refuse the external write operation based on transactional constraints, data integrity requirements, or other business rules. The validation mechanism helps ensure that external writes conform to the same standards and constraints that govern internal database operations, preventing data corruption or consistency violations.

The internal write pathway, starting from internal writes 136, shows how users can perform write operations through the RDBMS interface provided by relational database management system 102 using standard SQL syntax while the subject system transparently handles the complexity of writing to object storage format. In this mode, write operations are initiated using RDBMS syntax through the relational database management system 102, which coordinates with the RDBMS data lake module 104 to execute the write transaction. The RDBMS data lake module 104 applies transactional semantics to ensure that internal writes maintain ACID properties and can be properly committed or rolled back as part of larger database transactions. The data lake format engine 110 within the RDBMS data lake module 104 handles the translation of database write operations into the appropriate object storage format, while the catalog manager 108 ensures that the metadata and state information stored in catalog tables 118 accurately reflects the changes made to the data lake tables. The catalog API 106 provides the interface for coordinating these operations and maintaining consistency between the database representations and the actual files stored in object storage.

The architecture shown in FIG. 3 illustrates the transaction management capabilities that enable the subject system to support concurrent write operations from both internal and external sources while maintaining data consistency. The data lake table representations 116 stored within the database storage 112 serve as transactional anchors that allow the RDBMS data lake module 104 to apply database transaction semantics to operations that ultimately affect data stored in object storage 120. This architecture helps ensure that write operations, whether initiated internally through the RDBMS or externally through independent applications (e.g., executing on or provided by external system 132), are subject to the same transactional guarantees and consistency requirements, enabling the subject system to function as a unified transactional platform that spans both traditional relational database storage and object storage architectures.

In an implementation, write transactions on a data lake table stored in object storage 120 can also be performed in two ways:
1. by writing files directly to object storage 120 and updating the database storage 112 (e.g., at catalog tables 118) with the new state of the data file via the catalog API 106 implemented through (e.g., stored and maintained at) the RDBMS data lake module 104 (also referred to herein as “external writes”)
2. by writing to a representation of the data lake table provided via the RDBMS data lake module 104 using the regular data modification syntax of the relational database management system 102 (also referred to herein as “internal writes”).

In case of internal writes 136, the RDBMS data lake module 104 intercepts the write transactions using the APIs provided by the relational database management system 102. The RDBMS data lake module 104 performs a write transaction by writing data files 126 and metadata files 122 to object storage 120 according to the data lake table format, and then updates the internal catalog tables 118 of database storage 112 with the current state of the data lake table as part of the ongoing transaction. In case of transaction abort, the modification to the internal catalog tables 118 is reverted such that the internal catalog tables 118 that holds the current state of the data lake table remain unchanged.

When a write transaction makes changes to multiple tables, changes to catalog tables 118 are committed (made, updated) together and become visible to internal- and external-reads and writes simultaneously. In this manner, the transactional semantics of the data lake tables will match the transactional semantics of the relational database system itself.

For instance, in case of an insertion the RDBMS data lake module 104 may generate a new data file, as well as metadata files 122 in object storage 120 that reference the new data file. In case of an update or delete, the RDBMS data lake module 104 may scan the current set of data files 126 in the data lake table and obtain file names and row numbers for each of the rows. The RDBMS data lake module 104 may then write a file describing the deleted rows, or rewrite the existing data files 126 to exclude the deleted rows, and then generate metadata files 122 accordingly. After writing the data files 126 and metadata files 122 into object storage 120, the database storage 112 updates its internal catalog tables 118 with the identifier or URL of the top level metadata file that describes the new state of the table.

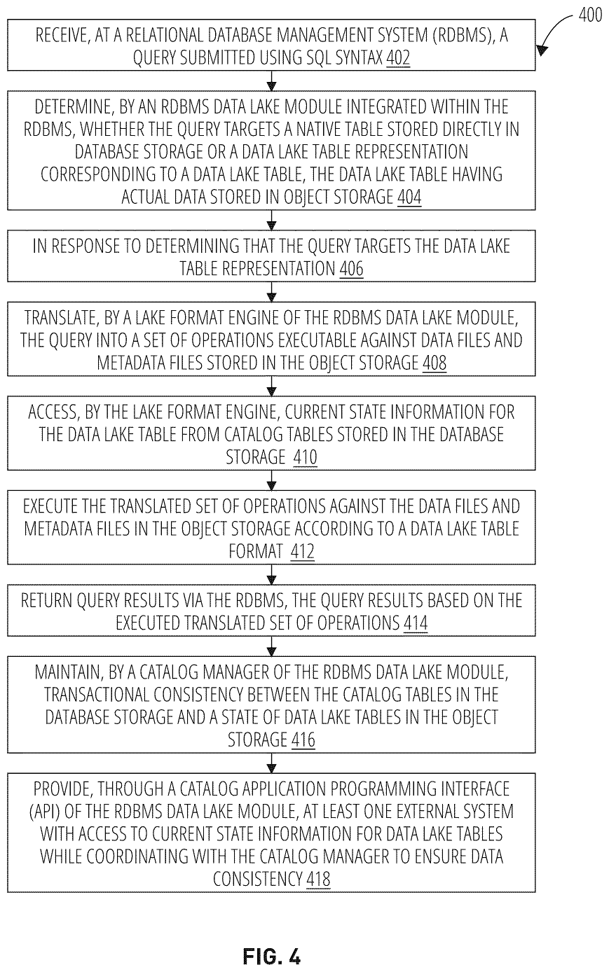

When write transactions are performed directly to object storage 120 by external system 132 (i.e., an external write), the external system 132 independently performs a write transaction according to the data lake table format via a separate library by writing files directly to object storage 120 and updating the database storage 112 with the new state of the data file via the catalog API 106 implemented through the RDBMS data lake module 104. In the final step, the external system 132 sends a request to update the current state of the table to the catalog (stored at database storage 112). The request is intercepted by the RDBMS data lake module 104, which can then validate the write and apply additional processing steps before deciding whether to commit it to its internal catalog tables 118. For instance, the database storage 112 may check newly added files against user-defined constraints on column values. In case of a violation, the transaction is aborted and writes to the internal catalog tables 118 are reverted, such that the current state of the data lake table (stored at object storage data files 126) remains unchanged. If the change is accepted, the change to the internal catalog tables 118 is committed by the database storage 112 and becomes visible to internal and external-reads and writes simultaneously. The RDBMS data lake module 104 may also evaluate triggers that can write to other data lake tables and database tables as part of the same transaction. FIG. 4 is a flow diagram illustrating operations of a system in performing a method 400, in accordance with some embodiments of the present disclosure. The method 400 may be embodied in computer-readable instructions for execution by one or more hardware components (e.g., one or more processors) such that the operations of the method 400 may be performed by components of RDBMS data lake module 104 (catalog API 106, catalog manager 108, data lake format engine 110) or relational database management system 102. Accordingly, the method 400 is described below, by way of example with reference thereto. However, it shall be appreciated that method 400 may be deployed on various other hardware configurations and is not intended to be limited to relational database management system 102 or RDBMS data lake module 104.

In operation 402, relational database management system 102 receives a query submitted using SQL syntax. In operation 404, RDBMS data lake module 104 determines whether the query targets a native table stored directly in database storage or a data lake table representation corresponding to a data lake table, the data lake table having actual data stored in object storage. In operation 406, in response to determining that the query targets the data lake table representation, components of RDBMS data lake module 104 perform the following operations. In operation 408, method 400 data lake format engine 110 translates the query into a set of operations executable against data files and metadata files stored in the object storage. In operation 410, data lake format engine 110 accesses current state information for the data lake table from catalog tables stored in the database storage. In operation 412, RDBMS data lake module 104 executes the translated set of operations against the data files and metadata files in the object storage according to a data lake table format. In operation 414, RDBMS data lake module 104 returns query results via the RDBMS, the query results based on the executed translated set of operations. In operation 416, catalog manager 108 maintains transactional consistency between the catalog tables in the database storage and a state of data lake tables in the object storage. In operation 418, catalog API 106 provides at least one external system (e.g., external system 132) with access to current state information for data lake tables while coordinating with the catalog manager to ensure data consistency.

As mentioned herein, “Relational Database Management System (RDBMS)” may refer to a traditional database system such as PostgreSQL, Oracle Database, or Microsoft SQL Server that stores and manages data using relational database principles and provides standard SQL query interfaces for data manipulation and retrieval. “Native tables” may refer to conventional database tables that store data directly within the RDBMS using traditional database storage mechanisms, as distinguished from data lake table representations.

As mentioned herein, “data lake tables” may refer to relational database tables stored as a collection of data files and metadata files in object storage, typically using open formats such as Apache Iceberg that enable multiple systems to access the same data without duplication. “Object storage” may refer to scalable, cost-effective storage systems that house data lake tables in the form of data files and metadata files, enabling efficient analytics operations while remaining accessible to multiple external systems. “Data files” may include the actual table data, typically stored in columnar formats such as Parquet for optimized analytics performance, while metadata files describe the structure, schema, transaction history, and current state of each data lake table.

As mentioned herein, “data lake table representations” may refer to intelligent pointer structures stored within the database that correspond to data lake tables whose actual data resides in object storage, enabling users to interact with remote data through familiar SQL interfaces as if the data were locally stored. “Catalog tables” may refer to maintain the current state information and metadata for all data lake tables within the database storage, serving as the authoritative source for both internal and external access coordination. “Current state” may refer to the authoritative metadata information that describes the latest committed version of each data lake table, including file locations, schema definitions, and transaction history.

As mentioned herein, “dual-mode access” may refer to the subject system's capability to support both internal and external operations against the same data lake tables simultaneously. “Internal reads” and “internal writes” may refer to operations performed through the RDBMS using standard SQL syntax, with the RDBMS Data Lake Module transparently handling the complexity of accessing data stored in object storage format. “External reads” and “external writes” are operations performed by external systems that access data lake tables independently while coordinating through the catalog API to ensure data consistency. “Transactional semantics” may refer to the ACID properties (Atomicity, Consistency, Isolation, Durability) maintained across operations involving both native tables and data lake table representations, enabling unified transaction management spanning traditional database storage and object storage architectures.

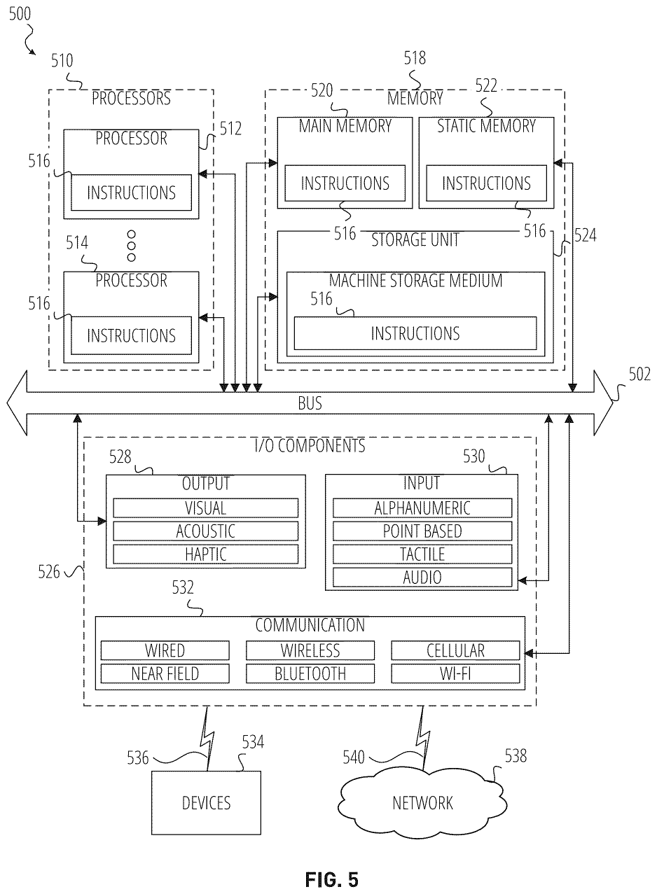

FIG. 5 illustrates a diagrammatic representation of a machine 500 in the form of a computer system within which a set of instructions may be executed for causing the machine 500 to perform any one or more of the methodologies discussed herein, according to an example embodiment. Specifically, FIG. 5 shows a diagrammatic representation of the machine 500 in the example form of a computer system, within which instructions 516 (e.g., a software, a program, an application, an applet, an app, or other executable code) for causing the machine 500 to perform any one or more of the methodologies discussed herein may be executed. For example, the instructions 516 may cause the machine 500 to execute any one or mor e operations of the method(s) described herein. As another example, the instructions 516 may cause the machine 500 to implement any one or more portions of the functionality illustrated in any one of FIG. 1, FIG. 2, and FIG. 3. In this way, the instructions 516 transform a general, non-programmed machine into a particular machine that is specially configured to carry out any one of the described and illustrated functions of the relational database management system 102, RDBMS data lake module 104 (or component thereof including catalog API 106, catalog manager 108, and data lake format engine 110).

In some embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines machine 500 that individually or jointly execute the instructions 516 to perform any one or more of the methodologies discussed herein.

The machine 500 includes processors 510, memory 518, and i/o components 526 configured to communicate with each other such as via a bus 502. In an example embodiment, the processors 510 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 514 and a processor 512 that may execute the instructions 516. The term “processor” is intended to include multi-core processors 510 that may comprise two or more independent processors (sometimes referred to as “cores”) that may execute instructions 516 contemporaneously. Although FIG. 5 shows multiple processors 510, the machine 500 may include a single processor with a single core, a single processor with multiple cores (e.g., a multi-core processor), multiple processors with a single core, multiple processors with multiple cores, or any combination thereof.

The memory 518 may include a main memory 520, a static memory 522, and a storage unit 524, all accessible to the processors 510 such as via the bus 502. The main memory 520, the static memory 522, and the storage unit 524 store the instructions 516 embodying any one or more of the methodologies or functions described herein. The instructions 516 may also reside, completely or partially, within the main memory 520, within the static memory 522, within the storage unit 524, within at least one of the processors 510 (e.g., within the processor's cache memory), or any suitable combination thereof, during execution thereof by the machine 500.

The i/o components 526 include components to receive input, provide output, produce output, transmit information, exchange information, capture measurements, and so on. The specific i/o components 526 that are included in a particular machine 500 will depend on the type of machine. For example, portable machines such as mobile phones will likely include a touch input device or other such input mechanisms, while a headless server machine will likely not include such a touch input device. It will be appreciated that the i/o components 526 may include many other components that are not shown in FIG. 5. The i/o components 526 are grouped according to functionality merely for simplifying the following discussion and the grouping is in no way limiting. In various example embodiments, the i/o components 526 may include output components 528 and input components 530. The output components 528 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 530 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The i/o components 526 may include communication components 532 operable to couple the machine 500 to a network 538 or devices 534 via a coupling 540 and a coupling 536, respectively. For example, the communication components 532 may include a network interface component or another suitable device to interface with the network 538. In further examples, the communication components 532 may include wired communication components, wireless communication components, cellular communication components, and other communication components to provide communication via other modalities. The devices 534 may be another machine or any of a wide variety of peripheral devices (e.g., a peripheral device coupled via a universal serial bus (USB)). For example, as noted above, the machine 500 may correspond to any one of the relational database management system 102, the execution platform RDBMS data lake module 104, and the devices 534 may include the database storage 112 or any other computing device described herein as being in communication with the relational database management system 102 or the RDBMS data lake module 104.

The various memories (e.g., memory 518, main memory 520, static memory 522, and/or memory of the processor(s) 510 and/or the storage unit 524) may store one or more sets of instructions 516 and data structures (e.g., software) embodying or utilized by any one or more of the methodologies or functions described herein. These instructions 516, when executed by the processor(s) 510, cause various operations to implement the disclosed embodiments. As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In various example embodiments, one or more portions of the network 538 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 538 or a portion of the network 538 may include a wireless or cellular network, and the coupling 540 may be a Code Division Multiple Access (CDMA) connection, a Global System for Mobile communications (GSM) connection, or another type of cellular or wireless coupling. In this example, the coupling 540 may implement any of a variety of types of data transfer technology, such as Single Carrier Radio Transmission Technology (133 RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 516 may be transmitted or received over the network 538 using a transmission medium via a network interface device (e.g., a network interface component included in the communication components 532) and utilizing any one of a number of well-known transfer protocols (e.g., hypertext transfer protocol (HTTP)). Similarly, the instructions 516 may be transmitted or received using a transmission medium via the coupling 536 (e.g., a peer-to-peer coupling) to the devices 534. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 516 for execution by the machine 500, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of a method may be performed by one or more processors. The performance of certain of the operations may be distributed among the one or more processors, not only residing within a single machine, but also deployed across a number of machines. In some example embodiments, the processor or processors may be in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
receiving, at a relational database management system (RDBMS), a query submitted using SQL syntax;
determining, by an RDBMS data lake module integrated within the RDBMS, whether the query targets a native table stored directly in database storage or a data lake table representation corresponding to a data lake table, the data lake table having actual data stored in object storage;
in response to determining that the query targets the data lake table representation:
translating, by a lake format engine of the RDBMS data lake module, the query into a set of operations executable against data files and metadata files stored in the object storage,
accessing, by the lake format engine, current state information for the data lake table from catalog tables stored in the database storage,
executing the translated set of operations against the data files and metadata files in the object storage according to a data lake table format, and
returning query results via the RDBMS, the query results based on the executed translated set of operations; and
maintaining, by a catalog manager of the RDBMS data lake module, transactional consistency between the catalog tables in the database storage and a state of data lake tables in the object storage.

2. The system of claim 1, wherein the operations further comprise:
in response to determining that the query targets a native table, processing the query using the RDBMS against data stored directly in the database storage.

3. The system of claim 1, wherein the operations further comprise:
providing, through a catalog application programming interface (API) of the RDBMS data lake module, at least one external system with access to current state information for data lake tables while coordinating with the catalog manager to ensure data consistency;
receiving, at the RDBMS, a create table command with a set of data lake format specifications; and
creating, by the RDBMS data lake module, a data lake table directly from within the RDBMS by generating data files and metadata files in the object storage according to the set of data lake format specifications, creating a corresponding data lake table representation in the database storage, and updating the catalog tables with state information for the created data lake table.

4. The system of claim 3, wherein providing at least one external system with access further comprises:
receiving, from an external system, a request for current state information for a specified data lake table;
responding, by the catalog API, with metadata information including file locations, schema information, and transaction history data; and
enabling the external system to directly access the data files and metadata files in object storage using the metadata information.

5. The system of claim 1, wherein the operations further comprise:
receiving a write request targeting a data lake table representation;
executing, by the lake format engine, a write operation against the object storage to create or modify data files and metadata files; and
updating, by the catalog manager, the catalog tables, stored in the database storage, with new state information as part of an atomic database transaction, wherein the write operation maintains a set of transactional properties consistent with a RDBMS operation.

6. The system of claim 5, wherein maintaining transactional consistency between the catalog tables in the database storage and the state of data lake tables in the object storage is based on the new state information, the new state information comprising identifiers or URLs of the metadata files that describe a new state of the data lake table.

7. The system of claim 1, wherein the operations further comprise:
performing internal read operations, the performing comprising:
receiving, at the RDBMS, a user query targeting a set of data lake tables, the query comprising SQL syntax,
translating, by the lake format engine, the user query into a set of operations executable against data stored in the object storage, and
handling, by the lake format engine, access to the data stored in the object storage while returning a set of query results through the RDBMS.

8. The system of claim 1, wherein the operations further comprise:
performing an external read operation, the performing comprising:
providing, through a catalog API, current state information to an external system accessing the same data lake tables, the external system being a different platform that is managed independently from the RDBMS,
enabling the external system to independently access the object storage based on the provided current state information, and
coordinating access to ensure the external system obtain consistent data from the data lake tables.

9. The system of claim 1, wherein the operations further comprise:
performing an internal write operation, the performing comprising:
receiving a write transaction via the RDBMS data lake module,
executing, by the lake format engine, a write operation against the object storage to create or modify data files and metadata files,
automatically updating the catalog tables with new state information as part of an atomic database transaction, wherein the catalog tables store pointers to top-level metadata files in the object storage, and the updating is committed or rolled back in coordination with other database operations, and
ensuring transactional consistency between updates to the object storage and the catalog tables.

10. The system of claim 1, wherein the operations further comprise:
performing an external write operation, the performing comprising:
receiving, from an external system, a write operation performed directly on the object storage, the external system being a different platform that is managed independently from the RDBMS,
receiving, through a catalog API, a validation request from the external system after completion of the write operation,
validating, by the RDBMS data lake module, the external write operation against a set of transactional constraints, data integrity requirements, or business logic rules, and
selectively updating the catalog tables based on a result of the validation to maintain system-wide consistency.

11. A method comprising:
receiving, at a relational database management system (RDBMS), a query submitted using SQL syntax;
determining, by an RDBMS data lake module integrated within the RDBMS, whether the query targets a native table stored directly in database storage or a data lake table representation corresponding to a data lake table, the data lake table having actual data stored in object storage;
in response to determining that the query targets the data lake table representation:
translating, by a lake format engine of the RDBMS data lake module, the query into a set of operations executable against data files and metadata files stored in the object storage,
accessing, by the lake format engine, current state information for the data lake table from catalog tables stored in the database storage,
executing the translated set of operations against the data files and metadata files in the object storage according to a data lake table format, and
returning query results via the RDBMS, the query results based on the executed translated set of operations; and
maintaining, by a catalog manager of the RDBMS data lake module, transactional consistency between the catalog tables in the database storage and a state of data lake tables in the object storage.

12. The method of claim 11, further comprising:
in response to determining that the query targets a native table, processing the query using the RDBMS against data stored directly in the database storage.

13. The method of claim 11, further comprising:
providing, through a catalog application programming interface (API) of the RDBMS data lake module, at least one external system with access to current state information for data lake tables while coordinating with the catalog manager to ensure data consistency;
receiving, at the RDBMS, a create table command with a set of data lake format specifications; and
creating, by the RDBMS data lake module, a data lake table directly from within the RDBMS by generating data files and metadata files in the object storage according to the set of data lake format specifications, creating a corresponding data lake table representation in the database storage, and updating the catalog tables with state information for the created data lake table.

14. The method of claim 13, wherein providing at least one external system with access further comprises:
receiving, from an external system, a request for current state information for a specified data lake table;
responding, by the catalog API, with metadata information including file locations, schema information, and transaction history data; and
enabling the external system to directly access the data files and metadata files in object storage using the metadata information.

15. The method of claim 11, further comprising:
receiving a write request targeting a data lake table representation;
executing, by the lake format engine, a write operation against the object storage to create or modify data files and metadata files; and
updating, by the catalog manager, the catalog tables, stored in the database storage, with new state information as part of an atomic database transaction, wherein the write operation maintains a set of transactional properties consistent with a RDBMS operation.

16. The method of claim 15, wherein maintaining transactional consistency between the catalog tables in the database storage and the state of data lake tables in the object storage is based on the new state information, the new state information comprising identifiers or URLs of the metadata files that describe a new state of the data lake table.

17. The method of claim 11, further comprising:
performing internal read operations, the performing comprising:
receiving, at the RDBMS, a user query targeting a set of data lake tables, the query comprising SQL syntax,
translating, by the lake format engine, the user query into a set of operations executable against data stored in the object storage, and
handling, by the lake format engine, access to the data stored in the object storage while returning a set of query results through the RDBMS.

18. The method of claim 11, further comprising:
performing an external read operation, the performing comprising:
providing, through a catalog API, current state information to an external system accessing the same data lake tables, the external system being a different platform that is managed independently from the RDBMS,
enabling the external system to independently access the object storage based on the provided current state information, and
coordinating access to ensure the external system obtain consistent data from the data lake tables.

19. The method of claim 11, further comprising:
performing an internal write operation, the performing comprising:
receiving a write transaction via the RDBMS data lake module,
executing, by the lake format engine, a write operation against the object storage to create or modify data files and metadata files,
automatically updating the catalog tables with new state information as part of an atomic database transaction, wherein the catalog tables store pointers to top-level metadata files in the object storage, and the updating is committed or rolled back in coordination with other database operations, and
ensuring transactional consistency between updates to the object storage and the catalog tables.

20. A non-transitory computer-storage medium comprising instructions that, when executed by one or more processors of a machine, configure the machine to perform operations comprising:
receiving, at a relational database management system (RDBMS), a query submitted using SQL syntax;
determining, by an RDBMS data lake module integrated within the RDBMS, whether the query targets a native table stored directly in database storage or a data lake table representation corresponding to a data lake table, the data lake table having actual data stored in object storage;
in response to determining that the query targets the data lake table representation:
translating, by a lake format engine of the RDBMS data lake module, the query into a set of operations executable against data files and metadata files stored in the object storage,
accessing, by the lake format engine, current state information for the data lake table from catalog tables stored in the database storage,
executing the translated set of operations against the data files and metadata files in the object storage according to a data lake table format, and
returning query results via the RDBMS, the query results based on the executed translated set of operations; and
maintaining, by a catalog manager of the RDBMS data lake module, transactional consistency between the catalog tables in the database storage and a state of data lake tables in the object storage.
